(19) United States
(12) Patent Application Publication
(10) Pub. No.: US 2025/0182979 A1
(43) Pub. Date: Jun. 5, 2025

(54) ON-LOAD TAP CHANGER AND TAP-CHANGING TRANSFORMER HAVING AN ON-LOAD TAP CHANGER

(71) Applicant: Maschinenfabrik Reinhausen GmbH, Regensburg (DE)

(72) Inventors: Christian Hammer, Regensburg (DE); Christian Kotz, Schorndorf (DE); Michael Schmeisser, Regensburg (DE); Simon Flotzinger, Aufhausen (DE)

(21) Appl. No.: 18/840,510

(22) PCT Filed: Feb. 6, 2023
(86) PCT No.: PCT/EP2023/052786

§ 371 Date: Aug. 22, 2024

(30) Foreign Application Priority Data
Mar. 3, 2022 (DE) 10 2022 105 034.3

(51) Int. Cl. H01H 9/00

(52) U.S. Cl. CPC H01H 9/0011; H01H 9/0016

(57) ABSTRACT

An on-load tap-changer is for uninterrupted diverter switch operation between different winding taps of a tap-changing transformer. The on-load tap-changer includes: a diverter switch; and a selector. The selector has a contact carrier with a plurality of fixed contacts. The selector also has a planetary gear with a first ring gear, a first planetary gear, and a first sun gear. The first ring gear includes a first selector contact configured for contacting the fixed contacts.

### CROSS REFERENCE TO RELATED APPLICATIONS

This application is a U.S. National Phase application under 35 U.S.C. § 371 of International Application No. PCT/EP2023/052786, filed on Feb. 6, 2023, and claims benefit to German Patent Application No. DE 10 2022 105 034.3, filed on Mar. 3, 2022. The International Application was published in German on Sep. 7, 2023 as WO 2023/1065782 A1 under PCT Article 21(2).

### FIELD

The present disclosure relates to an on-load tap-changer for uninterrupted diverter switch operation between different winding taps of a tap-changing transformer.

The present disclosure further relates to a tap-changing transformer having an on-load tap-changer for uninterrupted diverter switch operation between different winding taps of the tap-changing transformer.

### BACKGROUND

On-load tap-changers usually have a diverter switch and a selector. The diverter switch with the vacuum interrupters and the transition resistors is arranged in a cylindrical vessel. The selector is made up of a multiplicity of bars arranged in a circle. Contacts which serve as connections for winding taps of a tap winding are arranged at different levels on these bars. Two selector arms are secured to a switching pillar within the selector. These contact the contacts on the rods. The selector arms are operated by a complicated Geneva drive, which is arranged between the diverter switch and the selector.

### SUMMARY

In an embodiment, the present disclosure provides an on-load tap-changer for uninterrupted diverter switch operation between different winding taps of a tap-changing transformer. The on-load tap-changer includes: a diverter switch; and a selector. The selector has a contact carrier with a plurality of fixed contacts. The selector also has a planetary gear with a first ring gear; a first planetary gear; and a first sun gear. The first ring gear includes a first selector contact configured for contacting the fixed contacts.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an on-load tap-changer in a tap-changing transformer;

FIG. 2 shows a sectional view of the on-load tap-changer;

FIG. 3 shows a detailed sectional view of a selector;

FIG. 4 shows a detailed view of a planetary gear; and

FIG. 5 shows a further detailed view of the selector.

### DETAILED DESCRIPTION

Aspects of the present disclosure provide an on-load tap-changer that is simple and compact in design and provides a high degree of safety.

Aspects of the present disclosure provide a tap-changing transformer with an on-load tap-changer, which is simple and compact in design.

According to a first aspect, the present disclosure provides an on-load tap-changer for uninterrupted diverter switch operation between different winding taps of a tap-changing transformer, comprising: a diverter switch and a selector; wherein the selector has a contact carrier with a plurality of fixed contacts; the selector has a planetary gear with a first ring gear, a first planetary gear and a first sun gear; and the first ring gear has a first selector contact for contacting the fixed contacts.

The use of a planetary gear in the selector of an on-load tap-changer enables a particularly space-saving construction. The planetary gear, which is formed by a sun gear, a planetary gear and a ring gear, is particularly smooth, robust and can withstand particularly high torque loads. The fact that the ring gear not only transmits the movement, i.e. is a part of the planetary gear, but also comprises the selector contact, renders a separately designed selector arm superfluous. This also leads to an enormous reduction in the size of the selector and thus of the entire on-load tap-changer.

The selector can be designed in any manner, in particular, the selector and the planetary gear may comprise a first and a second ring gear, a first and a second planetary gear, and a first and a second sun gear. A first selector contact is arranged on the first ring gear, and a second selector contact is arranged on the second ring gear.

The selector contacts can be screwed, adhesively bonded, plugged to the ring gear, or be injection-molded on the latter. The ring gears thus not only form part of the planetary gear and transmit the rotational movement, but at the same time are the selector arms of the selector.

Each ring gear can be designed in any way, in particular, the first ring gear and/or the second ring gear can have a first and a second end position stop; the first and/or the second ring gear can have an internal toothing and the first and the second end position stop can be formed as wall elements at a respective end of the toothing.

The end position stops can be designed as wall elements or blocks. These can be part of the ring gears, or else be screwed, clamped or clipped to the ring gear. The end position stops are arranged at the end of the internal toothing, in particular in the region in which the planetary gear engages to transmit the rotational movement of the sun gear.

Each sun gear can be designed in any manner, for example, the first and the second sun gear can each have a partial toothing.

The partial toothing of the two sun gears allows the continuous rotational movement of the drive shaft to be converted into a gradual movement of the sun gears and thus the selector arms, i.e. the ring gears. An offset between the partial toothings of the two sun gears causes the ring gears to be actuated sequentially in time. The partial toothing of the first sun gear is offset from the partial toothing of the second sun gear.

Each sun gear can be designed in any manner, for example, the first and the second sun gear can be arranged on top of one another on a drive shaft.

The first sun gear, the first planetary gear and the first ring gear are formed or arranged in a mirror image by the second sun gear, the second planetary gear and the second ring gear on the drive shaft.

Furthermore, one or a plurality of main contacts can be arranged on the drive shaft between the selector and the diverter switch. These can be designed as simple contacts or sliding contacts.

The diverter switch can be designed in any manner and, for example, have semiconductor switching elements.

The contact carrier can be designed in any manner, for example to be tubular, and as a separate part of a flange module. The contact carrier is designed as an injection-molded part and is connected to the flange module by way of a form-fit or force-fit. The flange module in this instance is designed with multiple parts.

The contact carrier can be designed in any manner and, for example, form a unit with the flange module. The contact carrier is formed in this case in a section of the flange module.

According to a second aspect, the present disclosure proposes a tap-changing transformer having an on-load tap-changer comprising: housing; an active part with winding taps; wherein the on-load tap-changer is arranged above and/or next to the active part; the selector by way of its fixed contacts is connected in an electrically conductive manner to the winding taps of the active part.

The tap-changing transformer having the on-load tap-changer herein is of a particularly compact and safe construction.

The tap-changing transformer can be designed in any manner, wherein the on-load tap-changer is oriented horizontally or vertically inside the tap-changing transformer.

Aspects of the present disclosure and the advantages are described in more detail hereunder with reference to the appended drawings.

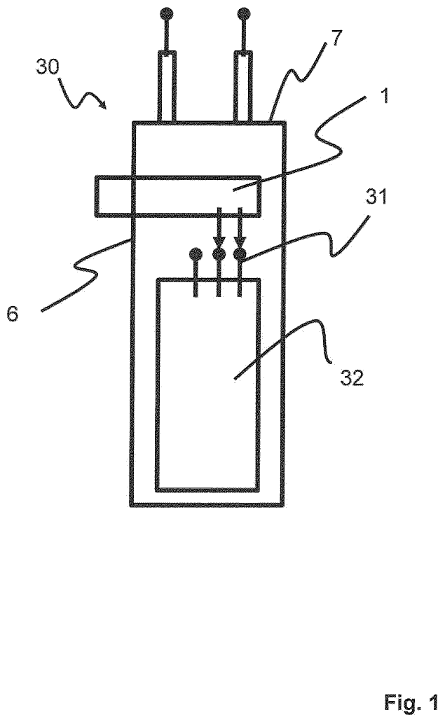

FIG. 1 shows an on-load tap-changer 1 for uninterrupted diverter switch operation between different winding taps 31 of a tap-changing transformer 30. The on-load tap-changer 1 is arranged on the inside horizontally above the active part 32 of the tap-changing transformer 30 and protrudes laterally from the housing 6 of the tap-changing transformer 30. As an alternative, the on-load tap-changer 1 can be arranged vertically, in which case it then protrudes from the housing 6 or the cover 7 at the top. The on-load tap-changer 1 is connected to the respective winding taps 31 of the active part 32 via lines.

The tap-changing transformer 30 is a single-phase or multi-phase distribution transformer which can be designed, in particular, as what is called a pylon transformer, service transformer, pad-mounted transformer or pole-mounted transformer. This tap-changing transformer is preferably used for voltages of up to 36 kV.

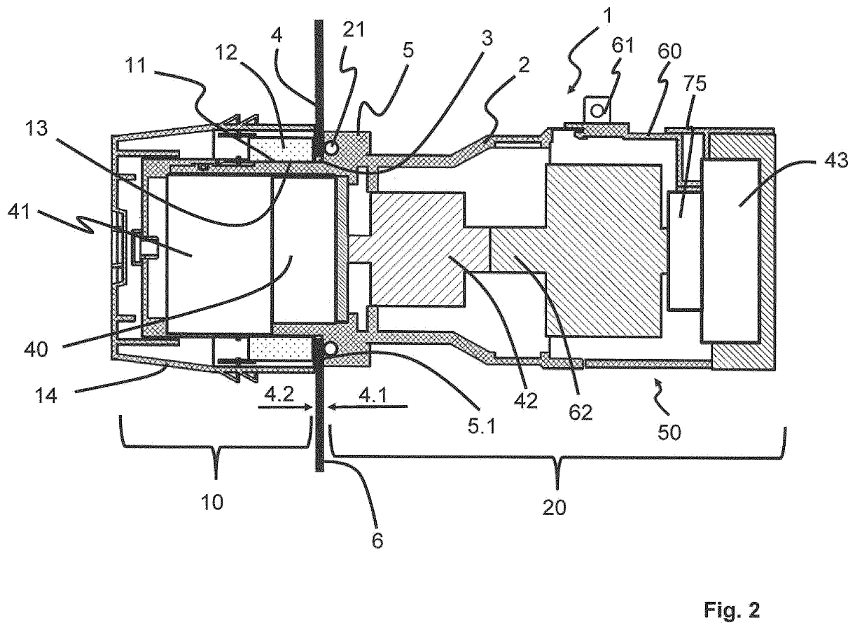

FIG. 2 shows a detailed sectional view of the on-load tap-changer 1 for uninterrupted diverter switch operation between different winding taps 31 of a tap-changing transformer 30. The on-load tap-changer 1 has a flange module 2 which is divided substantially into two regions. The first region 10 is separated from the second region 20 by a wall 4. After the on-load tap-changer 1 has been assembled, the first region 10 of the on-load tap-changer 1 is located outside the tap-changing transformer 30. The second region 20 of the on-load tap-changer 1 is located inside the tap-changing transformer 30.

When assembling the on-load tap-changer 1, the flange module 2 of the on-load tap-changer 1 is inserted through an opening 3 of the housing 6, here a wall 4 of the tap-changing transformer 30. This is possible because the flange module 2, and thus the on-load tap-changer 1, in the first region 10 has a smaller or approximately equal diameter in comparison to the diameter of the opening 3 in the wall 4 of the tap-changing transformer 30.

The flange module 2 has a flange 5 of which the diameter is greater than the diameter of the opening 3. The flange module 2 can protrude through the opening 3 of the wall 4 substantially only up to this flange 5. The flange 5 has a first face 5.1 which points to the inner side 4.1 of the wall 4 or housing 6. One or a plurality of seals in the form of one or a plurality of sealing rings 21 can be arranged between the first face 5.1 and the inner side 4.1 of the wall 4 when the on-load tap-changer 1 is in the assembled state. The seal or sealing ring 21 is therefore arranged between the flange module 2 and the housing 6. This prevents transformer oil that is inside the tap-changing transformer 30 from escaping.

The first region 10 of the flange module 2, which is arranged on the outer side 4.2 of the tap-changing transformer 30, has an at least partially formed thread 11 running on the circumference. The on-load tap-changer 1 is fastened to the housing 6 of the tap-changing transformer 30 by means of a union nut 12 which has an internal thread 13. By tightening the union nut 12, the flange module 2, and therefore the entire on-load tap-changer 1, is pressed against the inner side 4.1 of the housing 6 or the wall 4. The connection between union nut 12 and flange module 2 can also be implemented by means of latching cams or similar. In the process, the union nut 12 is consistently placed on the flange module 2 in order to fix the latter. The flange module 2 is supported on the inner side of the wall 4 of the tap-changing transformer 30 via the flange 5. In the embodiment shown here, a covering cap 14 is clipped onto the on-load tap-changer from the outside. This serves as protection against the weather.

The flange module 2 forms part of the on-load tap-changer 1. The control unit 40 and the communication unit 41 are arranged in the first region 10 of the flange module 2. These are accessible from the exterior, that is to say outside the tap-changing transformer 30. The drive 42, the diverter switch 43 and the selector 50 are arranged in the second region 20 which is arranged inside the tap-changing transformer 30. While the selector 50 is constructed from mechanical switches/contacts, the diverter switch 43 has semiconductor switching elements. The on-load tap-changer 1 is therefore what is referred to as a hybrid on-load tap-changer.

The flange module 2 in the region of the selector 50 has a contact carrier 60 on which a plurality of fixed contacts 61 are arranged. The contact carrier 60 is designed to be tubular and corresponds substantially to the cross section of the flange module 2. The contact carrier 60 can initially be formed as a separate part, but in the assembled state forms a unit with the flange module 2. The contact carrier 60 surrounds the individual elements of the selector 50 and holds distributed over its circumference the individual fixed contacts 61, which are connected to the individual winding taps 31 of a tap winding of a tap-changing transformer 30.

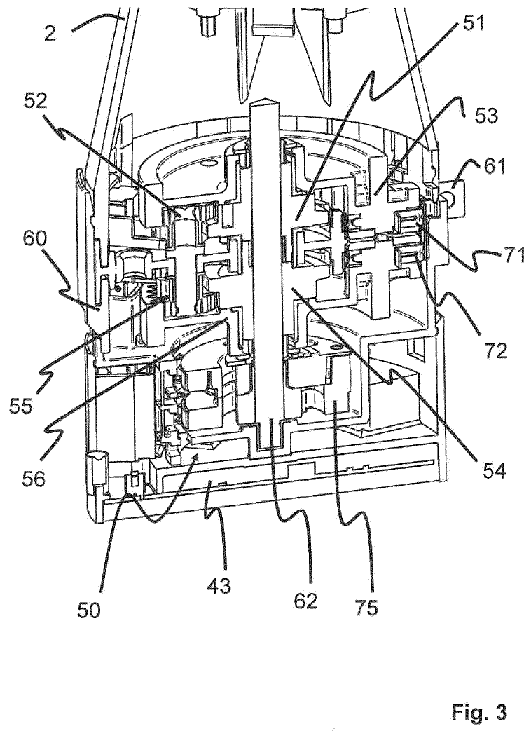

FIG. 3 shows a detailed sectional view of the selector 50 which is a part of the on-load tap-changer 1. A contact carrier 60 with the fixed contacts 61 is part of the flange module 2. The selector 50 comprises a first sun gear 51 which is arranged on a drive shaft 62 and connected to the latter. The first sun gear 51 has a partial toothing 69 on the circumference. Furthermore, a first planetary gear 52 and a first ring gear 53 are provided. The first planetary gear 52 is designed with partial toothing on the circumference, or has a partially toothed region 52/55. The first ring gear 53 has a first selector contact 71 on its outer contour, and an internal toothing 67 on an inner contour. During activation, i.e. when rotating the drive shaft 62, the first sun gear 51 is rotated by the drive shaft 62. The rotational movement is transmitted to the first planetary gear 52 by way of the latter's toothing. Since the planetary gear is only partially toothed, the rotation is only partially passed on to the first ring gear 53. This achieves that the first ring gear 53 is rotated only a few degrees, whereby the drive shaft 62 and the first sun gear 51 perform a 360 degree rotation.

The first ring gear 53 is furthermore designed as a first selector arm which comprises or carries the first selector contact 71 on the one hand, and is driven by a toothing 67 on the other hand, and performs the movement. The first selector contact 71 is connected directly to the first ring gear 52, or arranged on the latter

The selector 50 furthermore comprises a second sun gear 54 which is arranged on the drive shaft 62 and connected to the latter. The second sun gear 54 has a partial toothing 69 on the circumference. Furthermore, a second planetary gear 55 and a second ring gear 56 are provided. The second planetary gear 55 likewise has a partially toothed region 68 on the circumference. The second ring gear 56 on its outer contour has a second selector contact 72, and a toothing 67 on the inner contour. During activation, i.e. when rotating the drive shaft 62, the second sun gear 54 is rotated. The rotational movement is transferred to the second planetary gear 55 by way of the partial toothing 69. Since the latter is only partially toothed, the rotation is only partially passed on to the second ring gear 56. This achieves that the second ring gear 56 is rotated only a few degrees, whereby the drive shaft 62 and the second sun gear 54 perform a 360 degree rotation.

The second ring gear 56 is thus designed as a second selector arm which comprises or carries the second selector contact 72 on the one hand, and is driven by a toothing on the other hand, and carries out the movement. The second selector contact 72 is connected directly to the second ring gear 56, or arranged on the latter.

The first and the second sun gear 51, 54, the first and the second planetary gear 52, 54, and the first and the second ring gear 53, 56 form the planetary gear 59.

The first sun gear 51, the first planetary gear 52 and the first ring gear 53 correspond to the second sun gear 54, the second planetary gear 55 and the second ring gear 56, which are arranged only in a mirror image on top of one another on the drive shaft 62 in the selector 50.

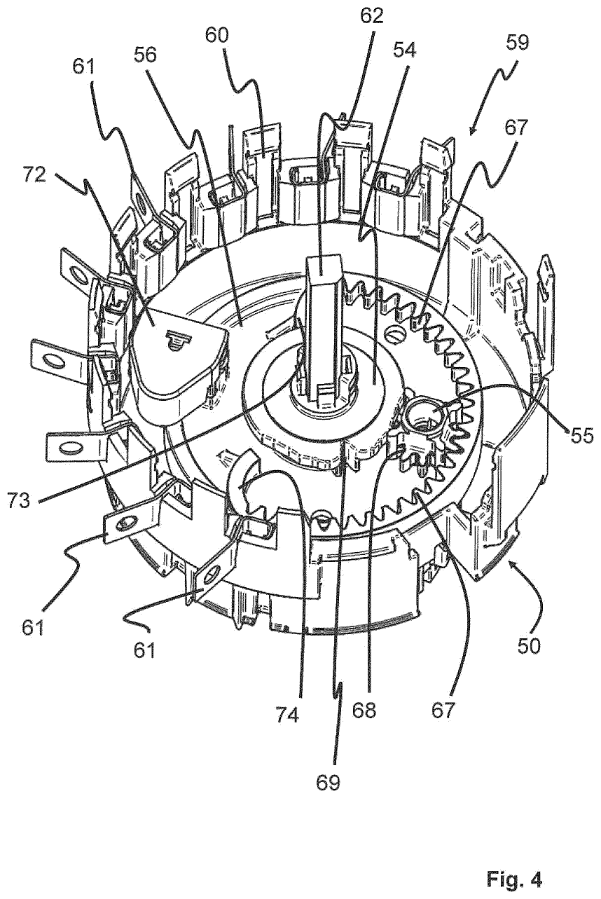

FIG. 4 shows part of the planetary gear 59. The second ring gear 56 has a second selector contact 72. The selector contact 72 is mechanically connected to the second ring gear 56. The second sun gear 54 is fastened to the drive shaft 62. The latter has a partial toothing 69 on its outer circumferential side. When activating (rotating) the drive shaft 62, the partial toothing 69 engages in the partially toothed region 68 of the second planetary gear 55 during rotation. The toothing of the second planetary gear 55 rotates and finally engages in the toothing 67 of the second ring gear 56. This toothing 67 is arranged on an inner contour of the ring gear 56. During operation, or when activating the selector 50, the drive shaft 62 performs one or a plurality of rotations, whereas the second ring gear 56 performs only part of a rotation, as a result of which a gradual rotational movement of the second ring gear 56 is created. When actuated, the second ring gear 56 rotates so far that the second selector contact 72 moves from a fixed contact 61 to the next fixed contact 61 and contacts this.

The internal toothing 67 is not formed over the entire inner contour of the ring gear 56. So-called end position stops 73, 74 are arranged at the start and at the end of the toothing 67. In the embodiment shown here, the first and the second end position stop 73, 74 are designed as wall elements. These serve to restrict the rotational movement of the second ring gear 56. This mechanically prevents the selector 50 from being activated beyond two defined points—the end positions. The second planetary gear 55 blocks the sun gear 54 and thus the rotation of the drive shaft 62 when the end position stops 73, 74 are reached.

The construction of the first sun gear 51, the first planetary gear 52 and the first ring gear 53 corresponds to the construction of the second sun gear 54, the second planetary gear 55 and the second ring gear 56. The first ring gear 53 also has two end position stops.

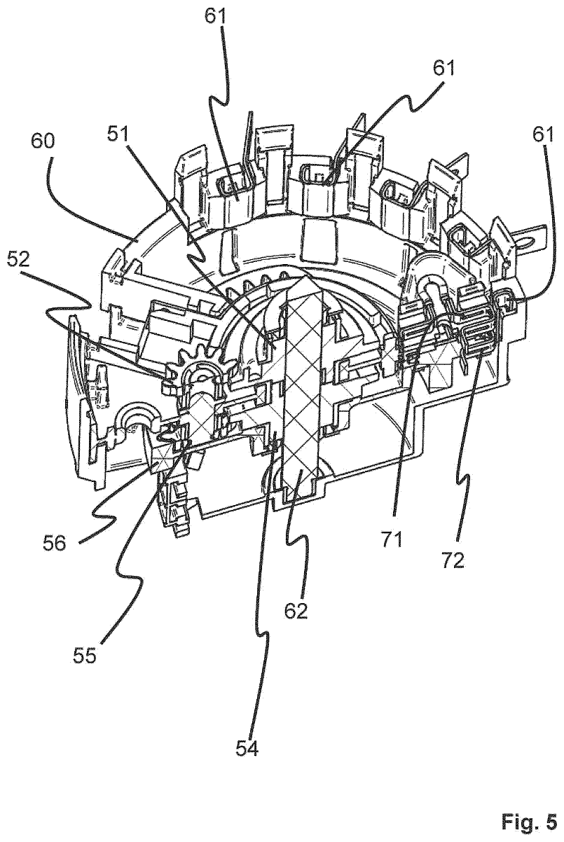

FIG. 5 shows a detailed view of the selector 50, in particular of the contact carrier 60. It is particularly clearly seen that the fixed contacts 61 extend outwards from an interior of the selector 50. In the interior, the fixed contacts 61 are contacted by the first and the second selector contact 71, 72.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE CHARACTER LIST

1 On-load tap-changer
2 Flange module
3 Opening
4 Wall
4.1 Inner side of 4
4.2 Outer side of 4
5 Flange
5.1 First face of 5
6 Housing
7 Cover
10 First region
11 Thread
12 Union nut
13 Internal thread
14 Covering cap
20 Second region
21 Seal or sealing ring
30 Tap-changing transformer
31 Winding taps
32 Active part
40 Control unit
41 Communication unit
42 Drive
43 Diverter switch
50 Selector
51 First sun gear
52 First planetary gear
53 First ring gear
54 Second sun gear
55 Second planetary gear
56 Second ring gear
59 Planetary gear
60 Contact carrier
61 Fixed contacts
62 Drive shaft
67 Internal toothing of 53/56
68 Partially toothed region of 52/55
69 Partial toothing of 51/54
71 First selector contact
72 Second selector contact
73 First end position stop
74 Second end position stop
75 Main contact

1: An on-load tap-changer for uninterrupted diverter switch operation between different winding taps of a tap-changing transformer, the on-load tap-changer comprising:
a diverter switch; and
a selector;
wherein:
the selector comprises a contact carrier comprising a plurality of fixed contacts;
the selector further comprises a planetary gear comprising a first ring gear; a first planetary gear; and a first sun gear; and
the first ring gear comprises a first selector contact configured for contacting the fixed contacts.

2: The on-load tap-changer as claimed in claim 1, wherein:
the planetary gear of the selector comprises a second ring gear; a second planetary gear; and a second sun gear, and
the second ring gear comprises a second selector contact for contacting the fixed contacts.

3: The on-load tap-changer as claimed in claim 1, wherein:
the first ring gear or the second ring gear comprises a first end position stop and a second end position stop.

4: The on-load tap-changer as claimed in claim 2, wherein:
the first ring gear or the second ring gear comprises an internal toothing and a first end position stop and a second end position stop are formed as wall elements at a respective end of the toothing.

5: The on-load tap-changer as claimed in claim 2, wherein:
the first sun gear and the second sun gear each have a partial toothing.

6: The on-load tap-changer as claimed in claim 2, wherein:
the first sun gear and the second sun gear are arranged on top of one another on a drive shaft.

7: The on-load tap-changer as claimed in claim 1, wherein:
the diverter switch comprises semiconductor switching elements.

8: The on-load tap-changer as claimed in claim 1, wherein:
the contact carrier is designed to be tubular and is a separate part of a flange module.

9: The on-load tap-changer as claimed in claim 8, wherein:
the contact carrier forms a unit with the flange module.

10: The on-load tap-changer as claimed in claim 1, wherein:
main contacts are arranged between the diverter switch and the selector.

11: A tap-changing transformer comprising the on-load tap-changer as claimed in claim 1, the tap changing transformer further comprising:
a housing; and
an active part comprising winding taps;
wherein:
the on-load tap-changer is arranged above or next to the active part, and
the selector by way of its fixed contacts is connected in an electrically conductive manner to the winding taps of the active part.

12: The tap-changing transformer as claimed in claim 11, wherein:
the on-load tap-changer is oriented horizontally or vertically.
